(19) United States
(12) Patent Application Publication
(10) Pub. No.: US 2014/0002652 A1
(43) Pub. Date: Jan. 2, 2014

(54) SYSTEM AND METHOD FOR IN VEHICLE LANE DETERMINATION USING CMOS IMAGE SENSOR

(71) Applicant: Amtech Systems, LLC, Albuquerque, NM (US)

(72) Inventors: Michael Gonzales, Albuquerque, NM (US); Kelly Gravelle, Poway, CA (US)

(21) Appl. No.: 13/899,389

(22) Filed: May 21, 2013

Related U.S. Application Data
(60) Provisional application No. 61/649,853, filed on May 21, 2012.
(60) Provisional application No. 61/811,490, filed on Apr. 12, 2013.

(51) Int. Cl. G07B 15/06; H04N 7/18

(52) U.S. Cl. CPC G07B 15/06; H04N 7/18
USPC 348/148; 455/456.1

(57) ABSTRACT

A system and method for vehicle lane determination using a CMOS image sensor camera to take periodic (or continuous) images of the road ahead of a vehicle. Using image processing techniques by counting how many road stripes or lines are to the left and right of the vehicle the current lane could be determined of that vehicle. Other information could also be determined by looking to see if the lines are solid or striped. Further embodiments include the use of a cellular telephone as the image sensor and to transit position information to a back office.

### CROSS-REFERENCE TO RELATED APPLICATIONS

This utility application claims priority to provisional application Ser. No. 61/649,853 entitled System and Method for In-Vehicle Lane Determination Using CMOS Image Sensor, filed on May 21, 2012 and to provisional application Ser. No. 61/811,490, entitled Apparatus for Infrastructure-free Roadway Tolling, filed on Apr. 12, 2013. The entire disclosures of these provisional applications are included herein by reference.

This utility application refers to provisional application Ser. No. 61/444,286 filed on Feb. 18, 2011; 61/445,636 filed on Feb. 23, 2011; 61/477,962 filed on Apr. 21, 2011; 61/545,650 filed on Oct. 11, 2011; 61/550,851, filed on Oct. 24, 2011, and all entitled “System and Method for GPS Lane and Toll Determination”; Ser. No. 61/498,453 filed on Jun. 17, 2011 and 61/510,933 filed on Jun. 22, 2011, both entitled “System and Method for Driver Performance Tracking” Ser. No. 61/568,472 filed on Dec. 8, 2011, entitled “System and Method for GPS Lane and Toll Determination and Asset Position Matching,” and Ser. No. 13/398,337 filed on Feb. 16, 2012 entitled System and Method for GPS Lane and Toll Determination and Asset Position Matching”; and Ser. No. 61/610358 filed Mar. 13, 2012 entitled “System and Method for Automated HOV Lane Toll Collection.” The entire disclosures of these provisional applications are included herein by reference.

### FIELD OF THE INVENTION

The invention relates generally to the field of vehicle tolling and particularly to determination of lane of travel of a vehicle.

### BACKGROUND

In the vehicle tolling field, low or no infrastructure systems and methods are being considered by service providers and highway agencies. Tolling systems that require little or no roadway equipment allow for rapid deployment of tolling schemes and can make concepts like congestion-pricing possible by charging tolls for roads that traditionally were not toll roads.

In the development of infrastructure-free tolling (IFT) concepts for a new way to deploy a High-Occupancy Toll lane (HOT) system the inventors considered using a smart phone to implement HOT and perhaps even IFT based tolling on traditional fee for use toll facilities.

The idea has appeal in that the cost of the hardware is already sunk by the consumer and the cost of data service might be folded into within existing customer data plans provided the data requirements were modest. However, two problems exist in offering a HOT smart phone application:

1. Cell Phone batteries die quickly with heavy GPS usage, reducing the appeal to consumers and potential operational complexities associated with lots of dead batteries

2. Most vexing was designing a practical method of enforcement. Vehicle tracking over a common carrier might work in concept, but it would require much higher data usage to “breadcrumb,” i.e. track the vehicle's course and expensive equipment in police vehicles to enforce. Latency of messaging in common carrier networks is not guaranteed and may be too slow to offer a practical enforcement approach

A U.S. Patent Application in this general area is publication number US 2011/0090075 A1, entitled “System and Method for Vehicle Performance Analysis” (Armitage, et al.). All references cited herein are incorporated by reference.

### DESCRIPTION OF THE DRAWINGS

FIG. 1 is a block diagram for a CMOS Image sensor lane determination system

FIG. 2 is a view of a section roadway with a geozone.

### DETAILED DESCRIPTION

TransCore's® ROVR concept was designed to solve the two problems outlined above. In the ROVR system (described in Ser. No. 13/298,337) GPS is powered by convenient standard port (the on-board diagnostics or OBD port) and a local low power radio that can transmit with very low latency the data needed by police for enforcement, with a simple and inexpensive enforcement module that is about 5×2.5×¾ inches and can fit in any glove compartment.

A user interface module (UIM) also communicates to ROVR via the local radio interface and provides an easy-to-use module. Because GPS technology cannot today provide reliable lane resolution positioning, the user not only self declares occupancy, but also self declares lane usage by pressing a single switch.

TransCore® has also recognized that a smart phone could fill the role of a user interface to the onboard tolling equipment, however, there are concerns that this is not the safest interface to use when the vehicle is in motion as required by the self-declaration of usage paradigm. A simple switch operation is safer than using the phone as a user interface because the switch is similar to many other functions of vehicle operation such as operating windshield wipers or turning on the radio. However, if the lane level resolution can be attained such that user interaction in motion is not required the smart phone application becomes more viable. If the GPS power draw on the cell phone can also be addressed as well a smart phone app becomes much more viable.

A new concept for lane determination is also disclosed herein to add an imager that can take photos of the view outside the vehicle that can be processed to determine lane and that this would be done by adding an imager to the UIM or by using a smart phone with a built in camera.

To overcome the aforementioned GPS power draw problem, a location monitoring unit (LMU) would still be provided that is powered by vehicle power and communicates with the phone over a Bluetooth® connection. The LMU could then use the phone hardware and the user's cell phone data plan for over the air connectivity, so that no cell phone hardware would be required in the LMU. The LMU could be in the form of an OBD port mounted device, a cell phone cradle, or a device that runs off the standard 12 VDC power port, or a USB connector present in many newer vehicles. A USB form factor could also be used for the LMU in conjunction with a power adaptor to either the standard 12 VDC power connector or the OBD port for maximum flexibility. The phone would be positioned phone at a standard attitude in the car such as in the center of the front dash or on the front windshield with dual lock (a 3M product similar to Velcro®) or in a transparent sleeve. This is done to set the smart phone positioned with its camera looking out of window.

The smart phone concept involves developing a HOT application that works in similar fashion to ROVR. In the existing ROVR system geo-zones are stored on the vehicle equipment and reported when intersected. In the system using a cell phone, the geo-zone information can be stored in the cell phone and the LMU reports position to the cell phone and the cell phone makes a comparison between current position and stored information and reports over the cellular network when a geo-zone is intersected, or the data can be stored and comparison made in the LMU, which reports to the cell phone to make the transmission over the cellular network to a back office.

The LMU provides periodic or continuous GPS data to the smart phone over the Bluetooth® link, or alternatively geo-zone intersections. When a toll zone is intersected as determined by the stored geo-zone function, one or more photos are taken by the cell phone of the view out of the windshield. These photos can be processed (either on the smart phone or sent to a back office) to determine how many lanes over the vehicle is from the median, thus determining without user intervention whether the vehicle is actually in the designated HOT lane. Visual cues can be lane lines diamond symbols, signage present by convenience or even signage place deliberately. Deliberate signage on sign bridges could be a very light infrastructure solution based on a smart phone application.

With the lane resolution problem solved, that makes a smart phone a viable user interface device. That leaves the enforcement problem. This can be addressed by Bluetooth® enabling the aforementioned cradle to talk to the smart phone application to verify proper operation, then provide enforcement data including vehicle description and license plate number and operating status over the enforcement radio link. This is disclosed in the aforementioned Ser. No. 13/298,337 application. This provides a highly viable, and enforceable IFT tolling and HOT concept. The cradle would be much less costly than an LMU. In an embodiment, the Bluetooth® radio is used directly as the enforcement radio link as described above. Typically the Bluetooth® links are not engineered with enough range or fast connect time and using Bluetooth® for this function may cause interference or connectivity problems with the LMU. However, more advanced blue Bluetooth® versions are being developed and if these issues are overcome by advancing technology, Bluetooth® may become a viable enforcement link as described above.

The smart phone acts as an interface to select the number of occupants by using touch screen buttons, including motion lock outs to make sure information is only inputted by the user with the vehicle stopped to ensure safe operation.

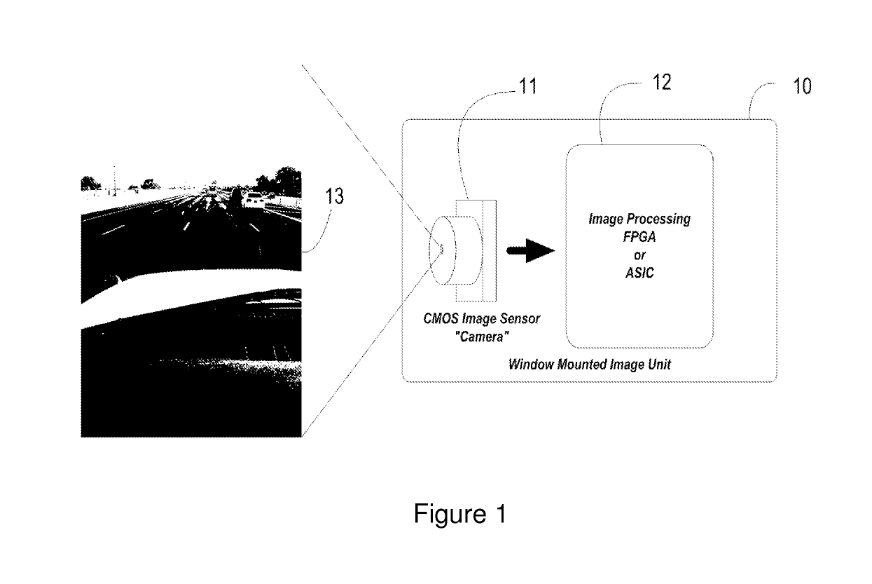

The following describes a system for vehicle lane determination using a CMOS image sensor “Camera” to take periodic (or continuous) images of the road ahead of a vehicle. Using image processing techniques by counting how many road stripes or lines are to the left and right of the vehicle the current lane could be determined of that vehicle. Other information could also be determined by looking to see if the lines are solid or striped. A small window mounted unit could be used to determine lane position, number of lanes to the left and right of the vehicles current position. This device (see FIG. 1) would have a CMOS image sensor that would be connected to an FPGA or ASIC for image processing and output simple lane location information.

The example in FIG. 1 shows that the window mounted unit 10, comprising a CMOS camera 11 and an image processing FPGA or ASIC 12 has determined from the image 13 that the vehicle is in the 3rd lane from the left or alternatively that there are three road stripes on the left and two on the right. Various types of output data could be produced, like number of stripes, solid lines, or even number of lanes on the left or right of the vehicle's current position. The window mounted unit can take pictures every few minutes (to conserve power) or be continuously run so that lane changes could be determined in real time.

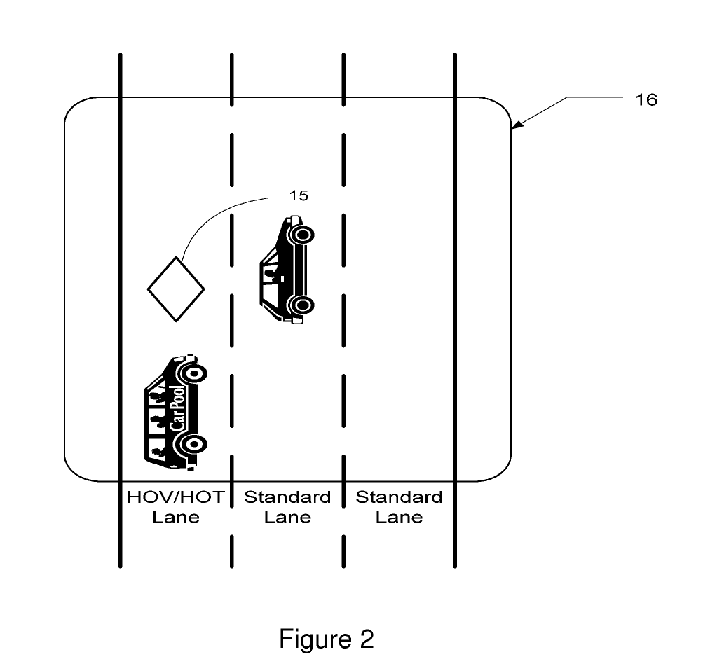

Additional functions for this technology would look for specific patterns on the road, as for example, high occupancy vehicle (HOV)/high occupancy toll (HOT) lane are indicated by diamond-shaped markers 15 in the center of the lane. By using the geographic (latitude, longitude) of the diamond marker the window mounted unit's camera could be switched on a short distance in front of that marker (at the start of a geozone see FIG. 2) to start to scanning for the diamond. If the vehicle has passed through the geozone 16 with no detection of the marker it could be determined that the vehicle was not using the HOT/HOV lanes. If the diamond marker is detected, then the vehicle could be considered in the HOT/HOV lanes. This technique could be expanded for other types of standard symbols that are already used on roadways or symbols or signs that are beside or above roadways. In the future, other types of symbols or text could be applied to the roadway, or near the roadway for various types of information uses.

All the techniques described above could be used in a software application for use on most smart phones. Most smart phones have the necessary camera, GPS, and processing power needed to detect solid, striped and roadway markers (on the ground and signs).

While certain representative embodiments and details have been shown for purposes of illustrating the invention, it will be apparent to those skilled in the art that various changes in the methods and apparatus disclosed herein many be made without departing from the scope of the invention.

1. A method for vehicle lane determination for a vehicle traveling in a multi-lane roadway, comprising
imaging the roadway with a CMOS sensor positioned in the vehicle,
processing said image to determining the vehicle's position relative to markings in the roadway and
determining the lane of travel of the vehicle.

2. The method of claim 1, wherein said roadway markings comprise line division markings.

3. The method of claim 1, wherein said roadway markings comprise graphic symbols to identify a particular lane.

4. The method of claim 3, wherein a diamond-shaped symbol identifies one of said multiple lanes.

5. The method of claim 1, further comprising
determining the vehicle's position relative to a predetermined geozone and only imaging said roadway when the vehicle is in or approaching said geozone.

6. A system for relaying vehicle location and lane position on a multiple lane roadway to a central office for tolling purposes, comprising:
an on board unit comprising a GPS receiver, and
a cellular telephone comprising a camera and a computer,
wherein, said on board unit tracks vehicle location, said cellular telephone is mounted in the vehicle such that said camera can photograph the roadway, said on board unit transmits position information to said cellular phone and said cellular phone transmits position information relative to fixed geo-data and lane information to the central office.

7. The system of claim 6, wherein said on board unit has data memory containing fixed location data and compares GPS data of current vehicle position to said fixed location data.

8. The system of claim 6, wherein said cell phone has data memory containing fixed location data and compares GPS data of current vehicle position to said fixed location data.

9. The system of claim 6, further comprising a low power RF transceiver for transmitting toll-related data to monitoring equipment located remotely from the vehicle.

10. A method for relaying vehicle location and lane position on a multiple lane roadway to a central office for tolling purposes, comprising:
tracking vehicle location with an on-board unit,
imaging the roadway with a cellular telephone is mounted in the vehicle,
determining lane information from said imaging,
transmitting vehicle position information from said on-board unit to said cellular phone and
transmitting position information relative to fixed geo-data and lane information to the central office via said cellular telephone.

11. The method of claim 10, wherein said on board unit has data memory containing fixed location data and further comprising the step of comparing GPS data of current vehicle position to said fixed location data.

12. The method of claim 10, wherein said cell phone has data memory containing fixed location data and further comparing GPS data of current vehicle position to said fixed location data.

13. The method of claim 10, further comprising transmitting toll-related data to monitoring equipment located remotely from the vehicle via low power RF transceiver.
